(19) United States
(12) Patent Application Publication
(10) Pub. No.: US 2002/0065078 A1
(43) Pub. Date: May 30, 2002

(54) Satellite-based multimedia telecommunication method and system

(75) Inventors: Michel Cohen, Paris (FR); Alain Delayre, L'Hay Les Roses (FR); Anne Henrotte, Paris (FR); Denis Rouffet, Boulogne Billancourt (FR); Joseph Blineau, Conflans Ste Honorine (FR)

Correspondence Address: SUGHRUE MION, PLLC, 2100 Pennsylvania Avenue, NW, Washington, DC, 20037-3213, US

(73) Assignee: ALCATEL

(21) Appl. No.: 09/988,636

(22) Filed: Nov. 20, 2001

(30) Foreign Application Priority Data
Nov. 24, 2000 (FR) 00 15 220

(51) Int. Cl. H04B 7/185

(52) U.S. Cl. 455/427; 455/428; 455/12.1

(57) ABSTRACT

A non-geosynchronous satellite telecommunication system provides interactive individual connections and each user of the system has a communication terminal including two data sender/receiver systems each of which is able to exchange data with a satellite independently of the other system and which are used alternately in time with the passage of the satellites so that between two changes of satellite one system is active and the other is held in reserve. In this system collective information is broadcast to all the satellites on at least one dedicated carrier which is received by the system held in reserve of each terminal.

### CROSS-REFERENCE TO RELATED APPLICATIONS

This application is based on French Patent Application No. 00 15 220 filed Nov. 24, 2000, the disclosure of which is hereby incorporated by reference thereto in its entirety, and the priority of which is hereby claimed under 35 U.S.C. §119.

### BACKGROUND OF THE INVENTION

1. Field of the Invention

The present invention relates to a telecommunication system and method using non-geosynchronous satellites simultaneously providing interactive individual connections and multicasting of collective information, and to a communication terminal forming part of this kind of system.

2. Description of the Prior Art

In the context of the present invention, the expression “collective information” refers to information of interest to some or all users of a communication system, with no facility for the sender of the information to select each potential receiver of the information individually.

Transmitting such information is known as “broadcasting” if it covers the whole of a population or “multicasting” if the addressees of the information are a subset of the population.

In a multimedia telecommunication system using a constellation of satellites, the population of potential addressees of collective information is limited to possessors of receiver terminals within the coverage area, or cell, of the satellite constellation. Thus the preferred term is “multicast” in this case.

The skilled person knows that in this kind of system each user sets up a connection on a carrier specific to the user and which is modulated to exchange data between the terminal of the user and the server or servers with which the terminal is communicating.

The data coming from the server is relayed by a terrestrial connection station, which sends it to a satellite in the form of radio signals. The satellite amplifies the signals and modifies their frequency (for technical reasons that will not be gone into here) to send them to the terminal of the user.

Data sent to the server by the user follows a reverse path: from the terminal of the user to the satellite, from the satellite to the terrestrial connection station, and from the terrestrial connection station to the terrestrial server.

The choice of which satellite to use to exchange data with the terminal of the user is the responsibility of the connection station, which knows the fixed geographical location of the terminal of the user and the instantaneous position of each satellite.

Given that they are at relatively low altitudes, the satellites are not geosynchronous and overfly the multicast cell. They take over from each other to provide the continuity of the connection for each user.

One major role of the connection station is to manage this overflying of the multicast cell by the satellites, by choosing a successor for any satellite quitting the multicast cell and determining the most appropriate time to switch the connection of each user from the outgoing satellite to the incoming satellite.

A device in the terminal of the user handles the change of satellite without loss of connection and at a time chosen by the connection station. The device consists of two sender/receiver systems each having its own independent antenna so that each of the two systems can track a satellite other than that tracked by the other system.

As long as the terminal remains connected to the same satellite, a single system is sufficient for it to exchange data and the other system is held in reserve.

When the satellite is on the point of no longer covering the terminal, it is necessary to prepare to switch the connection from the outgoing satellite to the incoming satellite. The antenna of the system held in reserve is then pointed at the incoming satellite, and when exchange of data with the incoming satellite via the system held in reserve becomes possible, the terminal switches to that system, which becomes the active system, whereas the other system becomes the system held in reserve.

By this alternate use of the two systems of the terminal, the changeover from one satellite to its successor is effected without interrupting the interactive connection.

What is more, the presence of two sender/receiver systems in the terminal enables the carrier to be changed without changing the satellite, which can be useful if the carrier in use is very congested.

The objective of the present invention is to add a multicast facility to this type of interactive telecommunication system so that users can continue to exchange data interactively via their individual connections whilst at the same time receiving collective information. The collective information can be recorded announcements, radio or TV programs, or specific software of interest to the users of the multicast cell, for example, such as operating software for the terminals themselves or training programs.

### SUMMARY OF THE INVENTION

The present invention consists in a method of multicasting collective information via a non-geosynchronous satellite telecommunication system which provides interactive individual connections and covers a multicast cell in which each user has a communication terminal including two data sender/receiver systems each of which is able to exchange data with a satellite independently of the other system and which are used alternately in time with the passage of the satellites so that between two changes of satellite one system is active and the other is held in reserve, in which method the collective information is broadcast to all the satellites on at least one dedicated carrier which is received by the system of each terminal that is held in reserve.

Of course, if a multicast cell is covered by several satellites, only those which are active in that cell are relevant to the invention.

The invention therefore exploits the presence of the system held in reserve, in the period between two changes of satellite, to enable the terminal to receive collective information.

In this case, the system held in reserve operates only in receive mode since, given the global nature of the information transmitted, the multicast facility is not interactive.

The invention is of particular benefit from the hardware point of view because it optimizes the use of the terminals without increasing their unit cost and without significantly modifying the remainder of the telecommunication system.

It should be noted that the availability of the system held in reserve is limited to periods between two changes of satellite, since preparing to switch over to the new satellite mobilizes said system held in reserve for as long as may be necessary to points its antenna at the new satellite, acquire the interactive connection data carrier or carriers of the new satellite and acquire the collective information multicast data carrier or carriers of the old active system, which becomes the system held in reserve, using the antenna pointed at the new satellite.

In one particular embodiment of the invention, in order for all users to receive the same data, the collective information is sent taking account of interruptions in the availability of the system held in reserve.

To this end, sending the collective information can systematically repeat data packets with a period at least equal to the period required to hand over the whole of the multicast cell completely from an outgoing satellite to an incoming satellite.

This period obviously depends on the constellation of satellites and the latitude at which the terminal concerned is located. It is not generally more than a few seconds.

In any event, the period chosen will be equally suitable for dealing with interruptions in the availability of the system held in reserve because of changes of carrier on the same satellite, since those interruptions are shorter than the interruptions on changing the satellite.

The advantage of this first solution is its great simplicity and its ability to accommodate all possible change of satellite situations.

Another solution is to repeat the data packets only during the period required to hand over all the terminals of the multicast cell from one satellite to another.

Solving the problem of interrupting the collective information multicast carrier by using a particular multicast mode avoids the need for a dedicated device in the connection station for managing interruptions, the main role of which station remains managing the movement of the satellites in relation to the interactive individual connections, which means that existing infrastructures are retained and optimized.

The invention also provides a communication terminal of a non-geosynchronous satellite telecommunication system providing interactive individual connections, the terminal including two data sender/receiver systems each of which is able to exchange data with a satellite independently of the other system and which are used alternately in time with the passage of the satellites so that between two changes of satellite one system is active and the other is held in reserve, in which terminal the system held in reserve is able to receive collective information between two changes of satellite.

In one particular embodiment of the invention the terminal includes a storage and/or compensation buffer memory area for providing data constituting the collective information at the output of the system held in reserve during change of satellite periods.

The invention also provides a non-geosynchronous satellite telecommunication system which provides interactive individual connections and includes a set of communication terminals as defined above and wherein each satellite is able to multicast a carrier dedicated to collective information and individual connection carriers.

To facilitate an understanding of the invention, one non-limiting embodiment of the invention is described next, with the aid of the accompanying drawings.

### BRIEF DESCRIPTION OF THE DRAWINGS

FIG. 1 is a diagrammatic representation of two sender/receiver systems of a terminal.

FIG. 2 is a perspective view of a multicast cell covered by two satellites.

FIG. 3 is a timing diagram showing the succession of operations executed in the terminal on the occasion of a change of satellite.

FIG. 4 is a timing diagram showing the succession of operations executed in the terminal on the occasion of a change of carrier with the same satellite.

### DETAILED DESCRIPTION OF THE PREFERRED EMBODIMENTS

The two sender/receiver systems A and B shown in FIG. 1 are identical, consisting of a receiver part 1 and a signal processor part 2.

Each receiver part includes an independent antenna 3, 4 adapted to be pointed at a satellite of the constellation forming the telecommunication system.

The antenna 3, 4 is connected to an electronic device 5, 6 providing low-noise amplification and frequency transposition functions for the radio signal received via the antenna.

A switching matrix 7 common to the two systems connects the receiver parts 1 to the signal processor parts 2 and can connect the signal processor parts of the two systems to a single receiver part and connect each signal processor part 2 to the receiver part of the same system or to the receiver part of the other system.

Each signal processor part 2 includes a series of conventional devices that are not described in detail here, namely a broadband filter 8, 9, a common carrier acquisition unit 10, a tracking unit 11, 12, a demodulator 13, 14, and a decoder 15, 16.

The two systems share the same compensation buffer memory 17, which in this example has an exceptionally high storage capacity to handle interruptions of the collective information carrier, as described below.

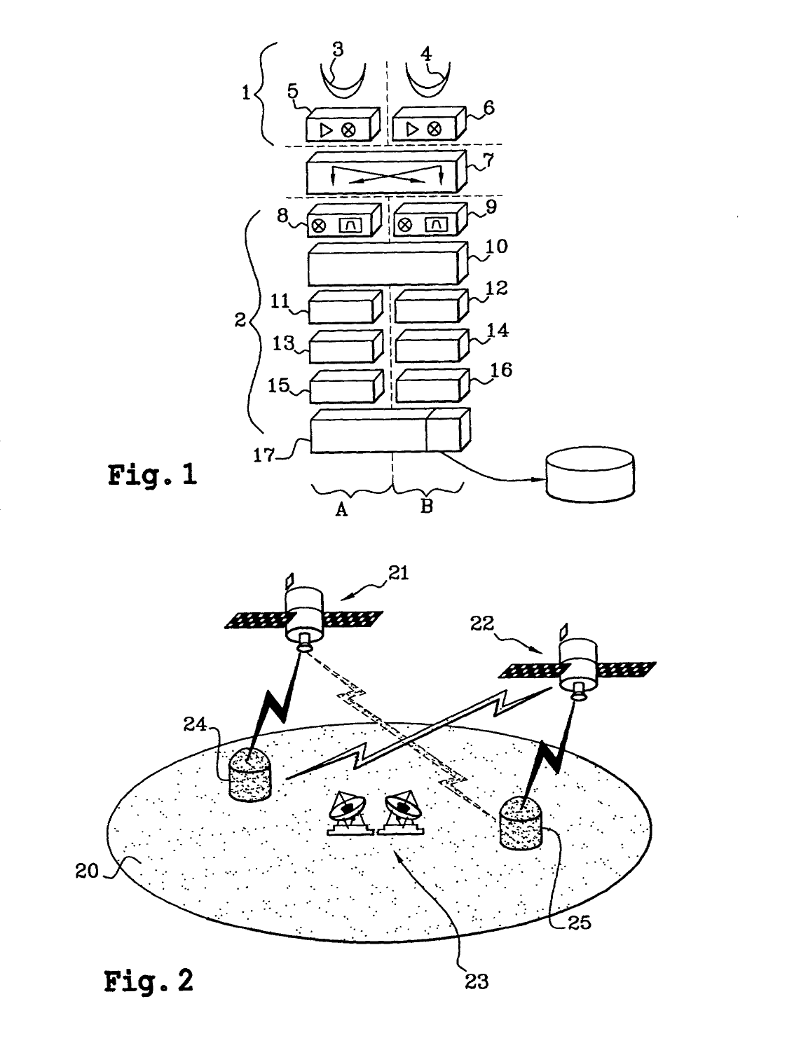

As can be seen in FIG. 2, a multicast cell 20 corresponds to a geographical area covered by a constellation of satellites 21, 22 of which only two are shown here.

The satellites 21, 22 overfly the multicast cell from East to West (i.e. from right to left in the drawing).

A connection station 23, which is preferably located in a central region of the multicast cell 20, handles the transmission of data between the terminals 24, 25 of users present in the multicast cell and servers (not shown) connected to said station 23 via the satellites 21, 22 which serve as radio relays.

The connection station 23 is continuously aware of the geographical location of each satellite. It is also aware of the location of each user terminal and can therefore decide in real time which satellite to use to provide the relay between itself and each user.

Data is transmitted between the satellite 21, 22 and the terminal 24, 25 using one of the two sender/receiver systems of said terminal. When that system is active, the other is held in reserve.

In a manner that is known to the skilled person, when the satellite 21 is about to cease covering the terminal 25, as it overflies the multicast cell, the connection station 23 anticipates the disappearance of the satellite 21 and prepares to switch the link to the other satellite 22, the successor of the preceding one in the sequence of satellites overflying the multicast cell.

Hereinafter, the expression “outgoing satellite” refers to the satellite 21 about to leave the cell and the expression “incoming satellite” refers to the satellite 22 about to replace it.

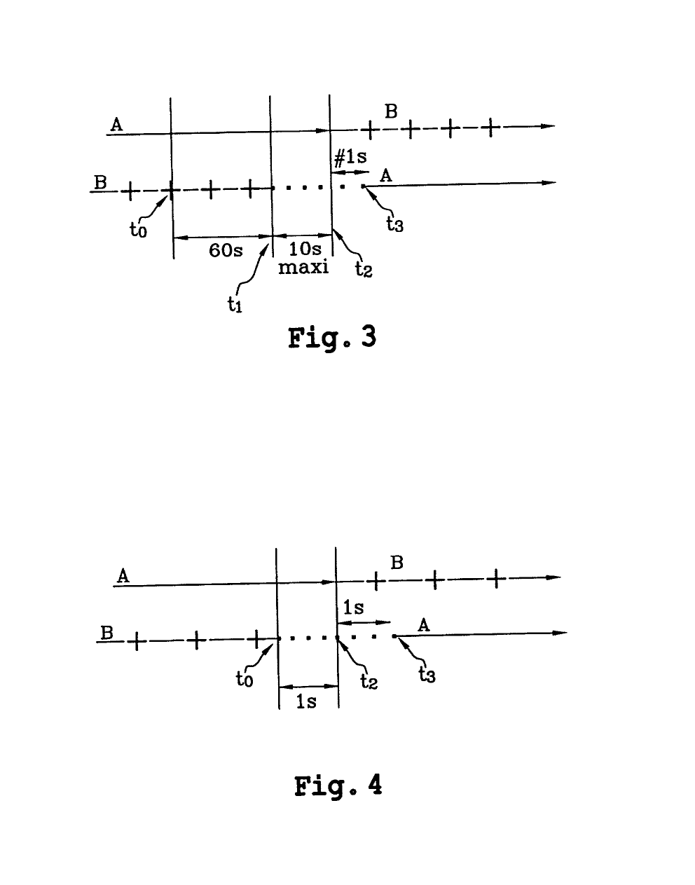

The change of satellite procedure is described with reference to FIG. 3, in which it can be seen that the system A of the terminal initially provides the user interactive connection, for example in accordance with an Internet protocol, whereas the other system B, which is held in reserve in the prior art, is used here to receive collective information on a carrier common to all the satellites.

The antenna 3 of the terminal points at the outgoing satellite and the switching matrix 7 connects the two signal processor parts to that antenna.

At time t₀ the connection station 23 sends an instruction to prepare to change satellite to the terminal 24 via the satellite 21 currently being used.

The terminal 24 receives that instruction and points its other antenna 4 at the incoming satellite 22.

After a period of a few tens of seconds, the antenna 4 is pointing at the incoming satellite 22.

The system B then ceases to receive collective information. The switching matrix 7 connects it to the antenna 4 pointing at the incoming satellite 22.

The system B begins acquisition of the Internet protocol carrier. This generally takes less than ten seconds.

Once acquisition has been completed (at time t₂), the system B can be used for the interactive connection of the user via the incoming satellite. The switching matrix effects the changeover immediately.

Thus the system A is released and the switching matrix modifies its configuration so that the system A is connected in turn to the antenna 4 pointing at the incoming satellite 22. It starts to acquire the collective information multicast carrier.

When acquisition is completed (time t₃), system A receives collective information in the same way as system B was doing before the change of satellite.

Note that the availability of the system not providing the connection is not continuous, because it is mobilized for each change of satellite.

To overcome this problem, data packets of the collective information program are multicast in a redundant manner.

Data lost during the period of unavailability of the system held in reserve was necessarily received before the period of unavailability or is necessarily received after the period of unavailability. Thanks to the storage and/or compensation buffer memory area 17 provided in the terminal, the data can be reconstituted as a continuous stream with no redundancy and supplied to the output of the system for use.

FIG. 4 shows a different situation, in which the sender/receiver system providing the interactive connection has to be changed because interactive traffic on the carrier adopted by the satellite is highly congested.

In this kind of situation, the carrier is changed but the same satellite is retained.

The protocol is similar to that previously described for a change of satellite, except that no aiming at a new satellite is required. Consequently, the time for which the collective information receiver system is unavailable is less than two seconds and the redundant multicast solution previously described is able to deal with the reception losses.

The embodiment described above is in no way limiting on the invention. It is provided for a better understanding of the invention, the scope of the invention being defined by the appended claims.

There is claimed:

1. A method of multicasting collective information via a non-geosynchronous satellite telecommunication system which provides interactive individual connections and covers a multicast cell in which each user has a communication terminal including two data sender/receiver systems each of which is able to exchange data with a satellite independently of the other system and which are used alternately in time with the passage of said satellites so that between two changes of satellite one system is active and the other is held in reserve, in which method said collective information is broadcast to all the satellites on at least one dedicated carrier which is received by said system of each terminal that is held in reserve.

2. The method claimed in claim 1 wherein said collective information is transmitted taking account of interruptions in the availability of said system held in reserve so that all said users receive the same data.

3. The method claimed in claim 2 wherein the transmission of said collective information systematically repeats data packets with a period at least equal to the time required to change the whole of said multicast cell over completely from an outgoing satellite to an incoming satellite.

4. The method claimed in claim 2 wherein the transmission of said collective information repeats said data packets only during periods of changing all said terminals of said multicast cell over from one satellite to another.

5. A communication terminal of a non-geosynchronous satellite telecommunication system providing interactive individual connections, said terminal including two data sender/receiver systems each of which is able to exchange data with a satellite independently of the other system and which are used alternately in time with the passage of said satellites so that between two changes of satellite one system is active and the other is held in reserve, in which terminal said system held in reserve is able to receive collective information between two changes of satellite.

6. The terminal claimed in claim 5 including a storage and/or compensation buffer memory area for providing data constituting said collective information at the output of said system held in reserve during change of satellite periods.

7. A non-geosynchronous satellite telecommunication system which provides interactive individual connections and includes a set of communication terminals as claimed in claim 5 and wherein each satellite is able to multicast a carrier dedicated to collective information and individual connection carriers.
